(19) United States
(12) Patent Application Publication
(10) Pub. No.: US 2026/0095423 A1
(43) Pub. Date: Apr. 2, 2026

(54) INFORMATION PROCESSING METHOD AND APPARATUS FOR INTELLIGENT CONVERSATIONS, AND ELECTRONIC DEVICE

(71) Applicant: Lenovo (Beijing) Limited, Beijing (CN)

(72) Inventor: Qihua XIAO, Beijing (CN)

(21) Appl. No.: 19/312,628

(22) Filed: Aug. 28, 2025

(30) Foreign Application Priority Data
Sep. 29, 2024 (CN) 202411378407.8

(51) Int. Cl. H04L 51/02

(52) U.S. Cl. CPC H04L 51/02

(57) ABSTRACT

An information processing method includes determining a first conversation group for conducting a conversation with a user that includes a plurality of conversation rounds each being a conversation between user input information and corresponding question/answer information, determining relevance between at least two conversation rounds in the first conversation group and time information associated with each conversation round in the first conversation group during the conversation, and determining a number of conversation rounds of a second conversation group to be output based on at least one of the relevance or the time information.

### CROSS-REFERENCE TO RELATED APPLICATION

This application claims priority to Chinese Patent Application No. 202411378407.8, filed on Sep. 29, 2024, the entire content of which is incorporated herein by reference.

### TECHNICAL FIELD

The present disclosure generally relates to the field of artificial intelligence and, more particularly, to an information processing method and apparatus for intelligent conversations, and an electronic device.

### BACKGROUND

During conversations (dialogues) with users using artificial intelligence, such as an AIGC (artificial intelligence generated content) conversation, a certain number of conversation rounds of conversation information, such as fixed two-round conversation information, is typically generated first. Subsequent conversation information is then determined based on the existing conversation information. However, the number of conversation rounds in subsequent conversation information is typically fixed, such as 30 rounds, which reduces flexibility. This may cause subsequent conversation information to be incompatible with the logic of the current conversation, reducing intelligence.

### SUMMARY

In accordance with the disclosure, there is provided an information processing method including determining a first conversation group for conducting a conversation with a user that includes a plurality of conversation rounds each being a conversation between user input information and corresponding question/answer information, determining relevance between at least two conversation rounds in the first conversation group and time information associated with each conversation round in the first conversation group during the conversation, and determining a number of conversation rounds of a second conversation group to be output based on at least one of the relevance or the time information.

Also in accordance with the disclosure, there is provided an electronic device including a memory storing an executable program, and a processor configured to execute the executable program to determine a first conversation group for conducting a conversation with a user that includes a plurality of conversation rounds each being a conversation between user input information and corresponding question/answer information, determine relevance between at least two conversation rounds in the first conversation group and time information associated with each conversation round in the first conversation group during the conversation, and determine a number of conversation rounds of a second conversation group to be output based on at least one of the relevance or the time information.

Also in accordance with the disclosure, there is provided a non-transitory computer-readable storage medium storing an executable program that, when executed by a processor, causes an electronic device including the processor to determine a first conversation group for conducting a conversation with a user that includes a plurality of conversation rounds each being a conversation between user input information and corresponding question/answer information, determine relevance between at least two conversation rounds in the first conversation group and time information associated with each conversation round in the first conversation group during the conversation, and determine a number of conversation rounds of a second conversation group to be output based on at least one of the relevance or the time information.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a flow chart of an information processing method for intelligent conversations consistent with embodiments of the present disclosure

FIG. 2 is a flow chart of S200 in an information processing method shown in FIG. 1 consistent with embodiments of the present disclosure.

FIG. 3 is another flow chart of S200 in an information processing method shown in FIG. 1 consistent with embodiments of the present disclosure.

FIG. 4 is another flow chart of S200 in an information processing method shown in FIG. 1 consistent with embodiments of the present disclosure.

FIG. 5 is another flow chart of S200 in an information processing method shown in FIG. 1 consistent with embodiments of the present disclosure.

FIG. 6 is a flow chart of S300 in an information processing method shown in FIG. 1 consistent with embodiments of the present disclosure.

FIG. 7 is another flow chart of S300 in an information processing method shown in FIG. 1 consistent with embodiments of the present disclosure.

FIG. 8 is a flow chart of another information processing method for intelligent conversation consistent with embodiments of the present disclosure

FIG. 9 is a schematic structural diagram of an information processing apparatus for intelligent conversations consistent with embodiments of the present disclosure.

### DETAILED DESCRIPTION OF THE EMBODIMENTS

Various schemes and features of the present disclosure are described herein with reference to the accompanying drawings.

It should be understood that various modifications may be made to the embodiments of the present disclosure. Therefore, the description should not be regarded as limiting, but only as examples of the embodiments. Based on the embodiments in the present disclosure, all other embodiments obtained by those skilled in the art without creative work are within the scope of the present disclosure.

The accompanying drawings, which are incorporated in and constitute a part of the present disclosure, illustrate embodiments of the present disclosure and, together with the general description of the present disclosure given above and the detailed description of the embodiments given below, serve to explain the principles of the present disclosure. These and other features of the present disclosure will become apparent from the following description of preferred forms of the embodiments, which are given as non-limiting examples, with reference to the accompanying drawings.

It should also be understood that although the present disclosure is described with reference to certain specific examples, those skilled in the art will readily be able to implement many other equivalent forms of the present disclosure.

The foregoing and other aspects, features, and advantages of the present disclosure will become more apparent from the following detailed description when taken in conjunction with the accompanying drawings.

Specific embodiments of the present disclosure will be described hereinafter with reference to the accompanying drawings. However, it should be understood that the described embodiments are merely examples of the present disclosure and may be implemented in many ways. Well-known and/or repetitive functions or structures are not described in detail to avoid obscuring the present disclosure with unnecessary or superfluous detail. Therefore, the specific structural or functional details described herein are not intended to be limiting but rather serve as a basis for the claims and as a representative basis to teach those skilled in the art to variously employ the present disclosure in substantially any suitable detailed configuration.

In the following description, this specification may use the phrases “in one embodiment,” “in another embodiment,” or “in some embodiments,” which may describe a subset of all possible embodiments, but it is understood that “some embodiments” can be the same subset or different subsets of all possible embodiments, and can be combined with each other without conflict.

The terms “first/second/third” involved are only used to distinguish similar objects, and do not represent a specific order for the objects. It is understood that objects described by “first/second/third” can be interchanged with a specific order or sequence where permitted, such that the embodiments of the present disclosure described here can be implemented in an order other than that illustrated or described here.

Unless otherwise defined, all technical and scientific terms used in the present disclosure have the same meaning as those generally understood by those skilled in the art. The terms used in the present disclosure are only for the purpose of description and are not intended to limit the scope of the present disclosure.

The present disclosure provides an information processing method for intelligent conversations. This information processing method may be applied to various intelligent scenarios as needed, such as intelligent product sales scenarios, intelligent customer service scenarios, or intelligent product after-sales scenarios. For example, the intelligent conversation may include multiple conversation groups. Based on content and logical relationships of the existing conversation groups, the method may predict the meaning of user input information, thereby predicting the user's interaction behavior with the artificial intelligence. Then, a number of conversation rounds in subsequent conversation groups that have not yet been output may be adjusted, such as increasing or decreasing the number of conversation rounds. This method may flexibly provide users with a conversation that is adapted to the current conversation scenario and meets their diverse needs.

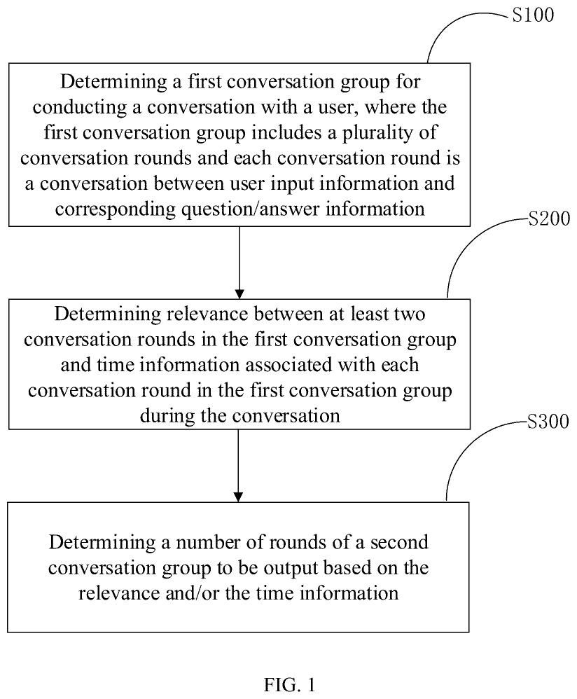

The following describes the information processing method for the intelligent conversations in detail with reference to the accompanying drawings. FIG. 1 is a flowchart of the information processing method for the intelligent conversations according to one embodiment of the present disclosure. As shown in FIG. 1, the method includes S100 to S300.

At S100, a first conversation group for a conversation with a user is determined. The first conversation group may include multiple conversation rounds, and each conversation round may be a conversation between user input information and corresponding question/answer information.

Exemplarily, an electronic device may be pre-configured with the first conversation group based on the usage scenario of the conversation with the user. The first conversation group may be used for intelligent interaction with the user. Of course, in various embodiments, the content and the number of conversation rounds of the first conversation group may be adjusted based on actual needs, thereby enabling intelligent interaction with the user input information.

The first conversation group may include the multiple conversation rounds and each conversation round may be a conversation between the user input information and the corresponding question/answer information. The user input information may be information entered by the user through a terminal when interacting with the electronic device (such as a server) or a corresponding intelligent system. The question/answer information in the conversation may be information posed by the electronic device or the corresponding intelligent system to the user, or information provided in response to the user input. For example, the question/answer information may include “How can I help you? ” or “Today's event information is . . . . ” The user input information and the corresponding question/answer information may form one conversation round.

The multiple conversation rounds in the first conversation group may be relevant to each other, forming a relatively complete interactive message. For example, the relevance between the content of the multiple conversation rounds may enhance content consistency during interaction with the user input information, allowing the user to experience the intelligence of the electronic device (or corresponding intelligent system).

In some embodiments, the content and the number of the conversation rounds in the first conversation group may be adjusted during the user interaction. For example, the number of the conversation rounds of the first conversation group may be pre-set to 2 or 3. During the interaction with the user, as the conversation rounds increase, all previously output conversations may be determined as part of the first conversation group. For example, if five conversation rounds have already occurred with the user, all previously output conversation content may be determined as part of the first conversation group, and the number of the conversation rounds in the first conversation group may be adjusted to 5.

In some other embodiments, the content and the number of the conversation rounds in the first conversation group may remain unchanged. For example, the number of the conversation rounds of the first conversation group may be pre-set to 2 or 3, and the rounds and corresponding conversation content may remain unchanged.

At S200, the relevance between at least two conversation rounds in the first conversation group, and time information associated with each conversation round of the first conversation group during the conversation process, are determined.

Exemplarily, the first conversation group may include the multiple conversation rounds, and at least two conversation rounds may have relevance. For example, if the first and second conversation rounds both express the same topic, the first and second conversation rounds may be determined to be relevant. Of course, the strength of this relevance may vary depending on the actual situation. In one embodiment, when determining the relevance between the at least two conversation rounds, the semantic relevance between each conversation round in the first conversation group and the corresponding conversation basis information for each conversation round may be obtained. The relevance between the at least two conversation rounds may be determined based on the semantic relevance and/or the conversation basis information.

In another embodiment, when determining the relevance between at least two conversation rounds, the relevance may be determined based on the degree of coherence of semantic expressions between adjacent conversation rounds in the first conversation group.

In yet another embodiment, when determining the relevance between at least two conversation rounds, a first relevance may be determined based on the degree of similarity between target objects addressed by each conversation round in the first conversation group.

In this embodiment, each conversation round in the first conversation group may have associated time information, including first time interval information between adjacent conversation rounds and second time interval information between the question/answer information and the user input information in each conversation round of the first conversation group. When the corresponding values of the first time interval information and/or the second time interval information are large, it may indicate that the content coherence between the corresponding conversation rounds is weak. Otherwise, it may indicate that the content of the corresponding conversation rounds is highly logical.

At S300, a number of conversation rounds of a second conversation group to be output is determined based on the relevance and/or the time information.

Exemplarily, the second conversation group may be a conversation group to be output by the electronic device, and the number of conversation rounds of the second conversation group may not be fixed. Instead, the number of conversation rounds of the second conversation group to be output may be determined based on the relevance between at least two conversation rounds in the first conversation group and/or the time information associated with each conversation round in the first conversation group.

In one embodiment, a preset number of conversation rounds of the second conversation group may be predetermined and then adjusted based on the relevance and/or the time information. In another embodiment, the preset number of conversation rounds of the second conversation group may not be predetermined, but may be determined based on a first comparison result of the relevance with a first relationship table and/or a second comparison result of the time information with a second relationship table. The first relationship table may include a first relevance between the relevance and the number of conversation rounds of the second conversation group, and the second relationship table may include a second relevance between the time information and the number of conversation rounds of the second conversation group.

For example, when at least two conversation rounds in a first conversation group have relatively strong relevance and/or the first time interval between adjacent conversation rounds in the first conversation group is relatively short, it may indicate that the first conversation group exhibits strong logic and intelligence in its interaction with the user. Therefore, a relatively large number of conversation rounds of the second conversation group may be determined based on the relevance and/or time information. On the other hand, when at least two conversation rounds in the first conversation group have relatively weak relevance and/or the first time interval between adjacent conversation rounds in the first conversation group is relatively long, it may indicate that the first conversation group exhibits poor logic and intelligence in its interaction with the user. Therefore, a relatively small number of conversation rounds of the second conversation group may be determined based on the relevance and/or time information.

After determining the number of conversation rounds of the second conversation group, the second conversation group may be output to further intelligently interact with the user. By appropriately determining the number of conversation rounds for the second conversation group, the intelligence of the electronic device in its interaction with the user may be effectively improved.

The information processing method for the intelligent conversations provided by the present application may determine the conversation rounds for the output second conversation group that is compatible with the current user interaction scenario based on the relevance between at least two conversation rounds in the preset first conversation group and the time information associated with each conversation round in the first conversation group.

Subsequent conversation information may be ensured to be consistent with the logic of the current conversation, effectively improving intelligence.

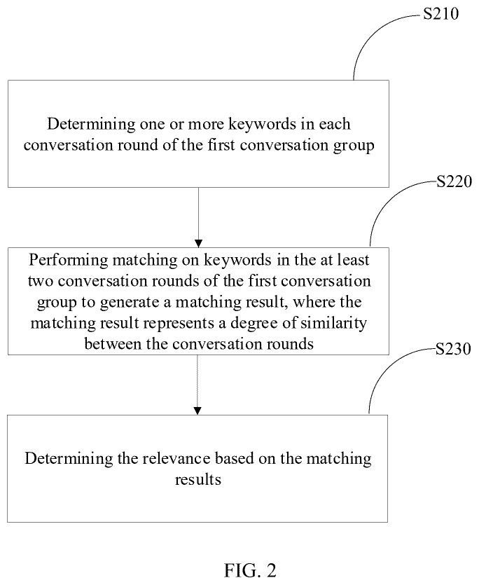

In one embodiment of the present disclosure, determining the relevance between at least two conversation rounds in the first conversation group, as shown in FIG. 2, includes S210 to S230.

At S210, one or more keywords in each conversation round of the first conversation group are determined.

For example, a keyword may include key word, number, letter, or other content surrounding each word in one conversation round. The keywords in each conversation round of the first conversation group may be determined based on the specific application scenario, the user input information, and/or user feedback on the question/answer information output by the electronic device.

For example, in an AI design and manufacturing scenario, during the interaction between the electronic device (or the intelligent system) and a user, the first conversation round in the first conversation group may include: “Help me write an AI-related introduction,” the second conversation round may include: “Help me revise the architecture design . . . ,” and the third conversation round may include: “Help me add the latest AI paper translations.” Each conversation round in the first conversation group mentions AI, such that AI-related terms may be identified as the keywords.

As another example, in a device technical support scenario, during the interaction between the electronic device (or intelligent system) and a user, each conversation round in the first conversation group may mention specific information related to a device failure, allowing this information related to the failure to be identified as the keywords.

In another embodiment, user-inputted content of interest, such as information including “product price,” “product price range,” or “price match,” may be obtained, and the content of interest may then be identified as keyword information.

At S220, matching is performed on keywords in at least two conversation rounds in the first conversation group to generate a matching result, where the matching result represents the degree of similarity between the conversation rounds.

For example, matching may be performed on keywords in at least two conversation rounds in the first conversation group for content similarity, such as performing matching on keywords in the first and second conversation rounds, or performing matching on keywords in the second and third conversation rounds, to determine whether the matching keywords are identical or similar in content, thereby determining whether the topics expressed in the corresponding conversation rounds are similar. The degree of similarity between the corresponding conversation rounds may then be determined.

In one embodiment, based on the keyword matching result, it may be determined that the keywords in the two conversation rounds are identical and both are related to product prices, thereby determining that the two conversation rounds have a high degree of similarity. This similarity may be represented by a specific numerical value.

In another embodiment, based on the keyword matching result, it may be determined that the keywords in the two conversation rounds, although different, have progressive meanings. For example, if the keyword in the first conversation round of the first conversation group is “new product release” and the keyword in the second conversation round of the first conversation group is “new mobile phone,” based on these keywords, it may be determined that the first conversation round and the second conversation round in the first conversation group have a high degree of similarity. This similarity may also be represented by a specific numerical value, with the numerical value increasing as the degree of similarity increases.

At S230, the relevance is determined based on the matching result.

Exemplarily, the matching result may be used to represent the degree of similarity between conversation rounds. Based on the matching result, a numerical value corresponding to the degree of similarity between the keywords in at least two conversation rounds in the first conversation group may be determined. When the numerical value exceeds a preset range, it may be determined that the two conversation rounds in the first conversation group are relevant. Otherwise, it may be determined that the two conversation rounds in the first conversation group are not relevant.

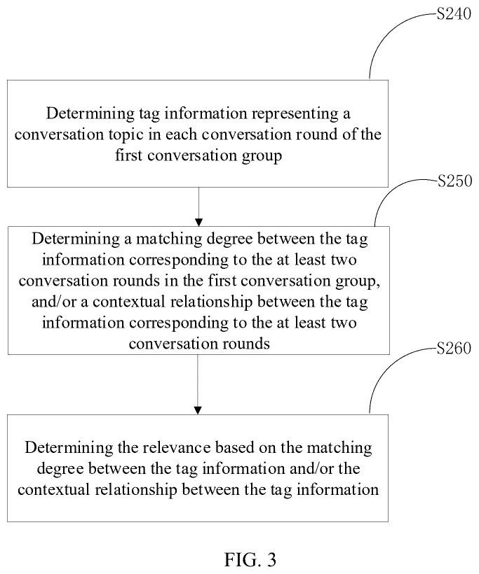

In another embodiment of the present disclosure, determining the relevance between at least two conversation rounds in the first conversation group, as shown in FIG. 3, includes S240 to 260.

At S240, tag information representing the conversation topic in each conversation round of the first conversation group is determined.

Exemplarily, the conversation topic may be the main focus of the corresponding conversation. Each conversation round in the first conversation group may have its own corresponding conversation topic. The conversation topic may be determined by semantically analyzing each conversation round in the first conversation group. For example, the conversation topic may be determined by semantically analyzing the user input information and the question/answer information output by the electronic device in each conversation round.

Each conversation topic may be associated with its own tag information, and different conversation topics may have different tag information. In one embodiment, a corresponding preset table may be determined based on the relevance between conversation topics and tag information. Once it is determined that each conversation round in the first conversation group has its own corresponding conversation topic, the corresponding tag information may be further determined based on the preset table.

At S250, the matching degree between the tag information corresponding to at least two conversation rounds in the first conversation group, and/or the contextual relationship between the tag information corresponding to at least two conversation rounds, is determined.

Exemplarily, the tag information corresponding to at least two conversation rounds in the first conversation group may be matched to determine the degree of relevance between the corresponding tag information. In one embodiment, the tag information may be represented by numerical values. Similar numerical values may indicate a close relevance between the corresponding different tag information, while significant numerical differences may indicate a low relevance between the corresponding different tag information.

In one embodiment, the tag information corresponding to at least two conversation rounds in the first conversation group may have a contextual relationship. This contextual relationship may represent a logical order and semantic cohesion, and may be determined through the intentional understanding of a model within the electronic device (intelligent system). For example, the contextual relationship may be determined by analyzing the logical order of the content between two adjacent conversation rounds using a large model, which includes analyzing and understanding the words and sentences in the conversations to determine the logical order of the content, and thus determining the contextual relationship.

In another embodiment, a template that includes the relevance between the tag information and the contextual relationships may be pre-configured. By matching the tag information with the template, the contextual relationship corresponding to the tag information may be determined. Of course, the template may be adjusted based on specific usage scenarios.

At S260, the relevance is determined based on the matching degree between the tag information and/or the contextual relationship between the tag information.

Exemplarily, the matching degree between tag information and the contextual relationship between tag information may both characterize the relevance between at least two conversation rounds in the first conversation group. Therefore, based on the matching degree between tag information and/or the contextual relationship between tag information, the relevance may be accurately determined.

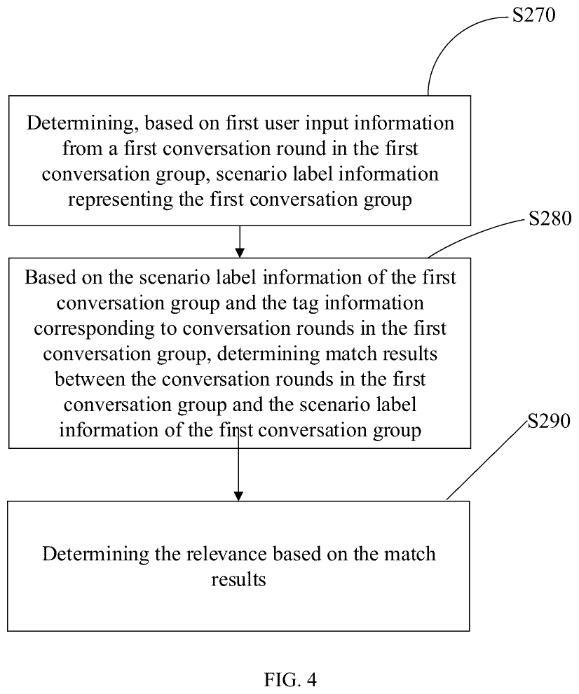

In one embodiment of the present disclosure, determining the relevance between at least two conversations in the first conversation group, as shown in FIG. 4, includes S270 to S290.

At S270, based on first user input information from the first conversation round in the first conversation group, scenario label information of the first conversation group is determined.

Exemplarily, the first user input information from the first conversation round in the first conversation group may be information entered by a user through a terminal during interaction with the electronic device (or intelligent system), and may represent the user's intention during the interaction. For example, the first user input information may be inquiring about after-sales service issues related to a purchased mobile phone. In this case, the current scenario in the first conversation group may be determined as an after-sales scenario. Based on the after-sales scenario, corresponding scenario label information may be determined. For example, the scenario label information may be “after-sales” or “mobile phone after-sales service,”or may be expressed in other non-textual form.

In another embodiment, the user may actively input information to directly determine the scenario label information. For example, when the first user actively inputs information such as “Requesting the intelligent customer service to classify this conversation as a conversation related to mobile phone after-sales service” the electronic device (or intelligent system) may directly classify the scenario label information as “mobile phone after-sales service.”

At S280, based on the scenario label information of the first conversation group and the tag information corresponding to the conversation rounds in the first conversation group, the matching results between the conversation rounds in the first conversation group and the scenario label information of the first conversation group are determined.

Exemplarily, the scenario label information may be used to comprehensively represent the usage scenario of each conversation round in the first conversation group. Each conversation round in the first conversation group may also have its own tag information, which characterizes the conversation topic of the corresponding conversation round. The scenario label information of the first conversation group may be matched with the tag information corresponding to each conversation round in the first conversation group. For example, when the scenario label information is “mobile phone after-sales service,” the tag information corresponding to each conversation round in the first conversation group may be “mobile phone after-sales service” or “pre-sales consultation.” The intelligent system of the electronic device may compare the tag information corresponding to each conversation round to the scenario label information to determine corresponding matching result. The matching result may be “same,” “similar,” or “different.” In some embodiments, a specific numerical value may also be used to represent the degree of similarity or difference.

At S290, the relevance is determined based on the matching results.

For example, the matching result may indicate the degree of similarity or difference between the tag information corresponding to the conversation round in the first conversation group and the scenario label information of the first conversation group. Based on the matching result, the relevance between at least two conversation rounds in the first conversation group may be determined. For example, when the matching results indicate that the tag information corresponding to the conversation rounds are same as the scenario label information of the first conversation group, the at least two conversation rounds in the first conversation group may be determined to have a strong relevance. Otherwise, when the matching result indicate that the tag information corresponding to the conversation round is different from the scenario label information of the first conversation group, the at least two conversation rounds in the first conversation group may be determined to have a low relevance.

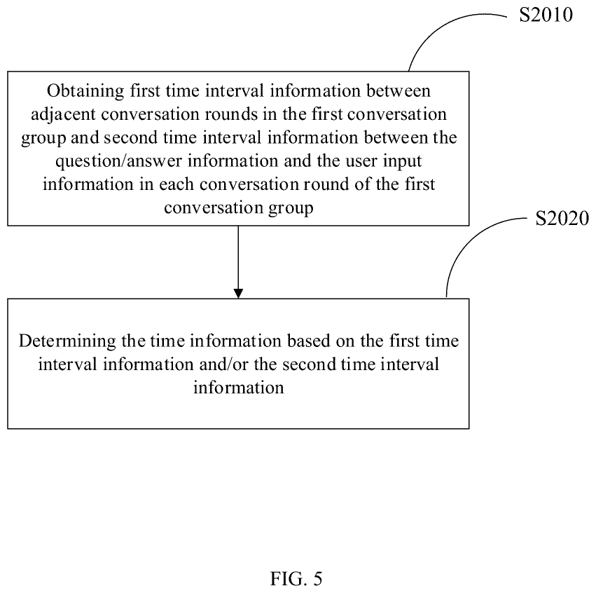

In one embodiment of the present disclosure, determining the relevance between at least two conversation rounds in the first conversation group and the time information associated with each conversation round in the first conversation group during the conversation, as shown in FIG. 5, includes S2010 to S2020.

At S2010, first time interval information between adjacent conversation rounds in the first conversation group, and second time interval information between the question/answer information and user input information in each conversation round in the first conversation group, are obtained.

For example, there may be a certain time interval between adjacent conversation rounds in the first conversation group, such as the time interval between the first and second conversation rounds in the first conversation group. In this embodiment, this time interval may be determined as the first time interval information. A shorter time value corresponding to the first time interval information may indicate a high likelihood that the conversation content topics of the adjacent conversation rounds are the same or similar, for example, when a user quickly interacts with the intelligent system about the same conversation topic within a short period of time. On the other hand, a longer time value corresponding to the first time interval information may indicate a low likelihood that the conversation content topics of the adjacent conversation rounds are the same or similar, for example, when a user consults with the intelligent system about a mobile phone at one time point and discuss computer after-sales service with the intelligent system at a second time point. The difference between the first and second time points may be relatively large.

In each conversation round in the first conversation group, there may also be a corresponding time interval between the user input information and the question/answer information output by the intelligent system. In this embodiment, this time interval may be determined as the second time interval information. When a user interacts normally with the intelligent system via a terminal, this time interval may not be excessively long. For example, when a user discusses pre-sales service for a mobile phone with the intelligent system, the time interval between user input information and the question/answer information output by the intelligent system may be similar to the time interval between human conversations. By analyzing the output times of each conversation round in the first conversation group and the time interval between the question/answer information and the user input information in each conversation round, the first time interval information and the second time interval information may be obtained, respectively.

At S2020, the time information is determined based on the first time interval information and/or the second time interval information.

Exemplarily, based on the first time interval information and/or the second time interval information, multiple time factors may be combined to accurately determine the time information associated with each conversation round in the first conversation group. Further, the relevance between at least two conversation rounds in the first conversation group may be determined based on the time information.

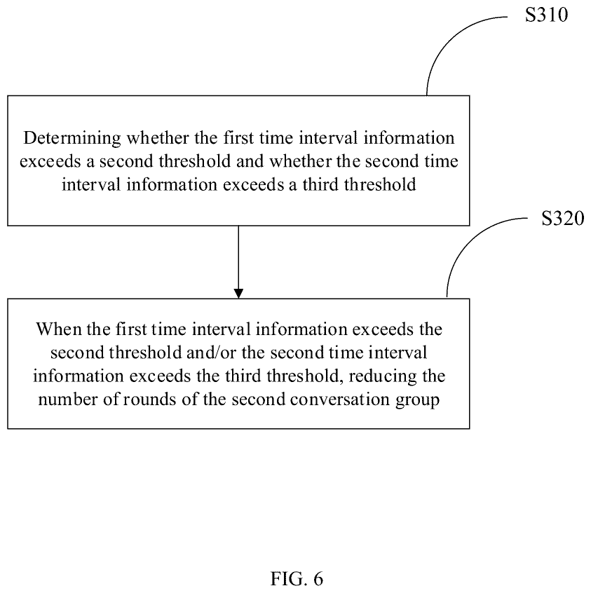

In one embodiment of the present disclosure, determining the number of conversation rounds of the second conversation group to be output based on the time information, as shown in FIG. 6, includes S310 to S320.

S310: determining whether the first time interval information exceeds a second threshold and whether the second time interval information exceeds a third threshold;

S320: when the first time interval information exceeds the second threshold and/or the second time interval information exceeds the third threshold, reducing the number of conversation rounds of the second conversation group.

As an example, the first time interval information may be compared with the second threshold. When it is determined that the first time interval information exceeds the second threshold, it may indicate that the time interval between adjacent rounds of conversation in the first conversation group may be long. For example, when the time interval between the first conversation round and the second conversation round exceeds the normal time interval for human-to-human conversation (e.g., more than one minute), it may indicate that the content of the adjacent rounds of conversation is different. In this case, the number of conversation rounds of the second conversation group may be reduced, thereby reducing the probability of conversational logic errors in the second conversation group and improving its intelligence.

Similarly, the second time interval information may be compared with the third threshold. When it is determined that the second time interval information exceeds the third threshold, it may indicate that the time interval between the question/answer information and the user input information in each conversation round in the first conversation group may be long, exceeding the normal time interval for human-to-human conversation. In this case, the number of conversation rounds in the second conversation group may be reduced, thereby reducing the probability of conversational logic errors in the second conversation group and improving the intelligence of the intelligent system.

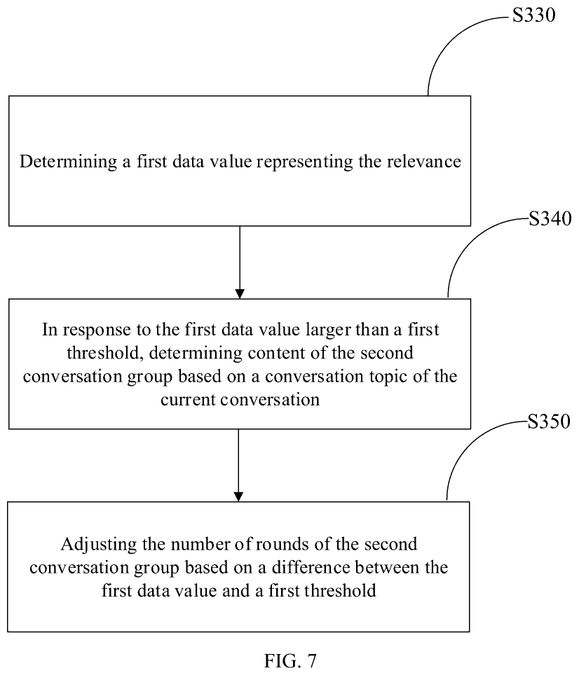

In one embodiment of the present disclosure, determining the number of conversation rounds of the second conversation group to be output based on the relevance and/or the time information, as shown in FIG. 7, includes S330 to S350.

At S330, a first data value used to represent the relevance is determined.

As an example, the relevance between at least two conversation rounds in the first conversation group may be represented by the first data value. A higher first data value may indicate a stronger relevance, while a lower first data value may indicate a weaker relevance. In this embodiment, a data value template may be pre-defined, containing relevance relationship between relevances of different strengths and specific data values. For example, a data value of 100 may correspond to a relevance of “extremely strong,” 90 may correspond to a relevance of “relatively strong,” and so on. A data value of 10 may correspond to a relevance of “very poor.”

At S340, when the first data value is larger than a first threshold, the content of the second conversation group is determined based on the conversation topic of the current conversation.

For example, the first threshold may be pre-set based on actual usage scenarios and historical experience. When the first data value is larger than the first threshold, it may indicate that at least two conversations in the first conversation group may be highly correlated, and the topic content of the current conversation may be likely to be involved by the user in the second conversation group to be output. Therefore, the content of the second conversation group may be determined based on the topic content of the current conversation. For example, the content of the second conversation group may be formed based on the topic content of the current conversation, as well as the logic of explanations between people and the progressive breadth and depth of the content.

At S350, the number of conversation rounds in the second conversation group is adjusted based on the difference between the first data value and the first threshold.

Exemplarily, the first data value may represent the relevance between at least two conversation rounds in the first conversation group. When the first data value is larger than the first threshold, the user conversation may be more active when the difference between the first data value and the first threshold is larger. Therefore, the number of conversation rounds in the second conversation group may be increased, such as by increasing the original number of conversation rounds by one. When the first data value is less than the first threshold, the user conversation may be less active when the difference between the first data value and the first threshold is larger. Therefore, the number of conversation rounds in the second conversation group may be decreased.

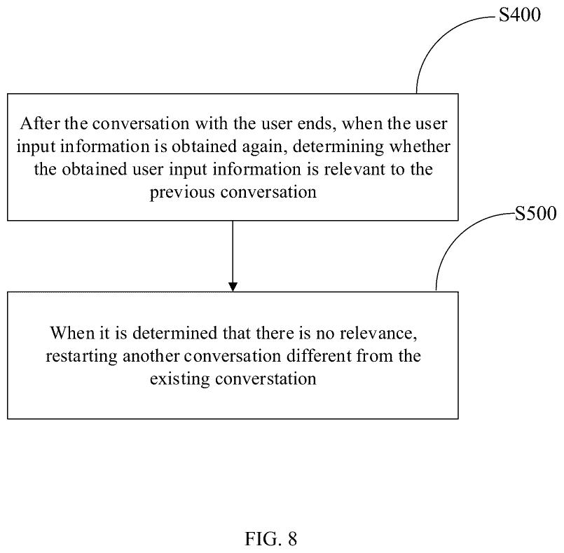

In one embodiment of the present disclosure, as shown in FIG. 8, the method further includes:

S400: after the conversation with the user ends, when the user input information is obtained again, determining whether the obtained user input information is relevant to the previous conversation; and

S500, when no relevance is determined, restarting a different conversation from the existing one.

Exemplarily, after the conversation with the user ends, the electronic device (or intelligent system) may output evaluation information of the conversation, encouraging the user to evaluate the conversation. The user may enter a review, marking the end of the current session.

When the user reconnects with the electronic device (or intelligent system) through the app, the electronic device (or intelligent system) may obtain the user input again and compare it with the subject matter of the previous session to determine whether there is any relevance between the user input and the previous session. For example, based on the specific content of the obtained user input, it may be determined that the subject matter of the current user interaction is different from the subject matter of the previous session, and thus, the obtained user input is not relevant to the previous session. The electronic device (or intelligent system) may then restart a different session, thus preventing the previous session from interfering with the current session.

In another embodiment, after the user session ends, when the user input is obtained again, whether there is any relevance between the obtained user input and the previous session may be determined. When there is relevance between the obtained user input and the previous session, the time interval between the time of the current user input and the end of the previous session may be obtained. When the time interval exceeds a fourth threshold, the number of conversation rounds in a third conversation group to be output may be reduced, or a different conversation may be restarted.

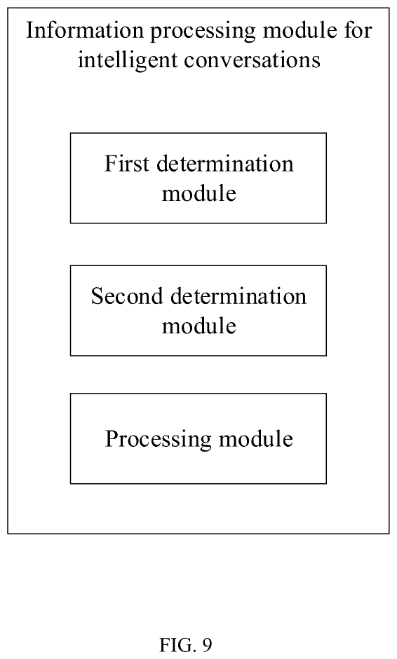

An embodiment of the present disclosure also provides an information processing apparatus for an intelligent conversation. As shown in FIG. 9, the apparatus includes a first determination module, a second determination module, and a processing module.

The first determination module may be configured to determine a first conversation group for conversations with a user. The first conversation group may include multiple conversation rounds, and each conversation round may be a conversation between user input information and corresponding question/answer information.

For example, an electronic device may be pre-configured with the first conversation group based on the usage scenario of the conversation with the user. This first conversation group may be used for intelligent interaction with the user. The content and number of conversation rounds of the first conversation group may be adjusted according to actual needs, thereby enabling intelligent interaction with user input information.

The first conversation group may include the multiple conversation rounds, and each conversation round may be a conversation between the user input information and the corresponding question/answer information. The user input information may be information entered by the user through a terminal when interacting with the electronic device (such as a server) or a corresponding intelligent system. The question/answer information in the conversation may be information asked by the electronic device or the corresponding intelligent system to the user, or information answered based on the user input information. For example, the question/answer information may be “How can I help you?” or “Today's event information is . . . ” The user input information and the corresponding question/answer information may form one conversation round.

The multiple conversation rounds in the first conversation group may be interconnected, forming a relatively complete set of interactive information. For example, the relevance between the content of the multiple conversation rounds may improve content consistency during interaction with user input information, thereby allowing users to experience the intelligence of the electronic device (or corresponding system).

On the one hand, the first determination module may adjust the content of the conversation rounds and the number of the conversation rounds in the first conversation group during interaction with the user. For example, the number of the conversation rounds of the first conversation group may be pre-set to 2 or 3. During the interaction with the user, as the number of the conversation rounds increases, the first determination module may determine all existing conversations as part of the first conversation group. For example, when five conversation rounds have been completed with the user, all existing conversation content may be determined as part of the first conversation group, adjusting the number of conversation rounds in the first conversation group to five.

On the other hand, the first determination module may not adjust the content of the conversation rounds and the number of the conversation rounds in the first conversation group. For example, the number of the conversation rounds in the first conversation group may be pre-set to 2 or 3, without adjusting the content of the conversation rounds and the number of the conversation rounds.

The second determination module may be configured to determine the relevance between at least two conversation rounds in the first conversation group, and time information associated with each conversation round in the first conversation group during the conversation process.

For example, the first conversation group may include the multiple conversation rounds, and at least two conversation rounds may be relevant. For example, when a first conversation round and a second conversation round express the same topic, the second determination module may determine that the first conversation round and second conversation round are relevant. Of course, the strength of this relevance may vary depending on the specific situation.

In one embodiment, when determining the relevance between the at least two conversation rounds, the second determination module may obtain the semantic relevance between each conversation round in the first conversation group and the corresponding conversation basis information for each conversation round; and determine the relevance between the at least two conversation rounds based on the semantic relevance and/or conversation basis information.

In another embodiment, when determining the relevance between the at least two conversation rounds, the second determination module may determine the relevance based on the degree of semantic coherence between adjacent conversation rounds in the first conversation group.

In yet another embodiment, when determining the relevance between the at least two conversation rounds, the second determination module may determine the first relevance based on the degree of similarity between the target objects addressed by each conversation round in the first conversation group.

In this embodiment, each conversation round in the first conversation group may have associated time information, and the time information may include a first time interval between adjacent conversation rounds and a second time interval between the question/answer information and the user input information in each conversation round of the first conversation group. When the corresponding values of the first time interval and/or the second time interval are large, it may indicate that the content of the corresponding conversation rounds is not coherent. Otherwise, it may indicate that the content of the corresponding conversation rounds is highly logical.

The processing module may be configured to determine the number of conversation rounds of the second conversation group to be output based on the relevance and/or the time information.

Exemplarily, the second conversation group may be a conversation group to be output by the electronic device, and the rounds of the second conversation group may not be fixed. Instead, the processing module may determine the rounds of the second conversation group to be output based on the relevance between at least two conversation rounds in the first conversation group and/or the time information associated with each conversation round in the first conversation group.

In one embodiment, the processing module may predetermine a preset number of conversation rounds for the second conversation group and then adjust the preset number of conversation rounds based on the relevance and/or the time information. In another embodiment, the processing module may not predetermine the preset number of conversation rounds for the second conversation group, but instead determine the preset number of conversation rounds for the second conversation group based on a first comparison result between the relevance and a first relationship table, and/or a second comparison result between the time information and a second relationship table. The first relationship table may record the first relationship between the relevance and the rounds of the second conversation group, and the second relationship table may record the second relationship between the time information and the rounds of the second conversation group.

For example, when the relevance between at least two conversation rounds in the first conversation group is relatively strong, and the first time interval between adjacent conversation rounds in the first conversation group is relatively short, it may indicate that the first conversation group exhibits strong logic and intelligence in its interactions with the user. Therefore, the processing module may determine a relatively large number of conversation rounds for the second conversation group based on the relevance and/or time information. When the relevance between at least two conversation rounds in the first conversation group is relatively weak, and the first time interval between adjacent conversation rounds in the first conversation group is relatively long, it may indicate that the first conversation group exhibits poor logic and intelligence in its interactions with the user. Therefore, the processing module may determine a relatively small number of conversation rounds for the second conversation group based on the relevance and/or time information.

After determining the number of conversation rounds of the second conversation group, the second conversation group may be output to further enable intelligent interaction with the user. Because of the appropriate determination of the number of conversation rounds of the second conversation group, the intelligence of the electronic device in interacting with the user may be effectively improved.

Optionally, in one embodiment, the second determination module may be further configured to:
determine keywords in each conversation round of the first conversation group;
perform matching on the keywords in at least two conversation rounds in the first conversation group to generate matching result, where the matching result is used to represent the similarity between the conversation rounds; and
determine the relevance based on the matching result.

Optionally, in one embodiment, the second determination module may be further configured to:
determine tag information representing the conversation topic in each conversation round of the first conversation group;
determine the matching degree between the tag information corresponding to at least two conversation rounds in the first conversation group, and/or the contextual relationship between the tag information corresponding to at least two conversation rounds; and
determine the relevance based on the matching degree between the tag information and/or the contextual relationship between the tag information.

Optionally, in one embodiment, the second determination module may be further configured to:
determine, based on the first user input information of the first conversation round in the first conversation group, scenario label information used to characterize the first conversation group;
determine, based on the scenario label information of the first conversation group and the tag information corresponding to the conversation rounds in the first conversation group, the matching results between the conversation rounds in the first conversation group and the scenario label information of the first conversation group; and
determine the relevance based on the matching results.

Optionally, in one embodiment, the second determination module may be further configured to:
obtain first time interval information between adjacent conversation rounds in the first conversation group, and second time interval information between the question/answer information and the user input information in each conversation rounds of the first conversation group; and
determine the time information based on the first time interval information and/or the second time interval information.

Optionally, the processing module may be further configured to:
determine whether the first time interval information exceeds a second threshold and whether the second time interval information exceeds a third threshold; and
when the first time interval information exceeds the second threshold and/or the second time interval information exceeds the third threshold, reduce the number of conversation rounds in the second conversation group.

Optionally, the processing module may be further configured to:
determine a first data value representing the relevance;
when the first data value is larger than a first threshold, determine the content of the second conversation group based on the conversation topic of the current conversation;
adjust the number of conversation rounds of the second conversation group based on the difference between the first data value and the first threshold.

Optionally, the processing module may be further configured to:
after a conversation with the user ends, when the user input information is obtained again, determine whether the obtained user input information is related to the previous conversation; and
when no relevance is determined, restart a different conversation than the existing one.

The present disclosure also provides an electronic device. The electronic device may include a memory and a processor. The memory may be configured to store an executable program, and the processor may be configured to execute the executable program to implement the information processing method provided by any embodiment of the present disclosure.

The above describes in detail a plurality of embodiments of the present disclosure, but the present disclosure is not limited to these specific embodiments. Those skilled in the art can make various variations and modifications based on the concept of the present disclosure, and these variations and modifications should fall within the scope of protection of the present disclosure.

What is claimed is:

1. An information processing method comprising:
determining a first conversation group for conducting a conversation with a user, the first conversation group including a plurality of conversation rounds each being a conversation between user input information and corresponding question/answer information;
determining relevance between at least two conversation rounds in the first conversation group and time information associated with each conversation round in the first conversation group during the conversation; and
determining a number of conversation rounds of a second conversation group to be output based on at least one of the relevance or the time information.

2. The method according to claim 1, wherein determining the relevance includes:
performing matching on keywords in the at least two conversation rounds to generate a matching result that indicates a degree of similarity between the at least two conversation rounds; and
determining the relevance based on the matching result.

3. The method according to claim 1, wherein determining the relevance includes:
determining tag information representing a conversation topic in each conversation round of the first conversation group;
determining at least one of a matching degree between tag information characterizing topics of the at least two conversation rounds or a contextual relationship between the tag information corresponding to the at least two conversation rounds;
determining the relevance based on the at least one of the matching degree or the contextual relationship.

4. The method according to claim 1, wherein determining the relevance includes:
determining, based on user input information from one conversation round in the first conversation group, scenario label information of the first conversation group;
determining, based on the scenario label information and tag information characterizing topics of the at least two conversation rounds, match results each between one of the at least two conversation rounds and the scenario label information; and
determining the relevance based on the match results.

5. The method according to claim 1, wherein determining the time information associated with each conversation round in the first conversation group includes, for one conversation round in the first conversation group:
obtaining first time interval information between the one conversation round and an adjacent conversation round in the first conversation group and second time interval information between the question/answer information of the one conversation round and user input information; and
determining the time information associated with the one conversation round based on at least one of the first time interval information or the second time interval information.

6. The method according to claim 5, wherein determining the number of conversation rounds of the second conversation group includes:
determining whether the first time interval information exceeds a first threshold and whether the second time interval information exceeds a second threshold; and
in response to the first time interval information exceeding the first threshold and/or the second time interval information exceeding the third threshold, reducing the number of conversation rounds of the second conversation group.

7. The method according to claim 1, wherein determining the number of conversation rounds of the second conversation group includes:
determining a data value representing the relevance;
in response to the data value being larger than a threshold, determining content of the second conversation group based on a conversation topic of a current conversation; and
adjusting the number of conversation rounds of the second conversation group based on a difference between the data value and the threshold.

8. The method according to claim 1, further comprising, after the conversation with the user ends:
in response to obtaining the user input information again, determining whether the obtained user input information is relevant to the previous conversation; and
in response to determining that the obtained user input information is not relevant to the previous conversation, restarting another conversation different from the existing conversation.

9. An electronic device comprising:
a memory storing an executable program; and
a processor configured to execute the executable program to:
determine a first conversation group for conducting a conversation with a user, the first conversation group including a plurality of conversation rounds each being a conversation between user input information and corresponding question/answer information;
determine relevance between at least two conversation rounds in the first conversation group and time information associated with each conversation round in the first conversation group during the conversation; and
determine a number of conversation rounds of a second conversation group to be output based on at least one of the relevance or the time information.

10. The electronic device according to claim 9, wherein the processor is further configured to execute the executable program to, when determining the relevance:
perform matching on keywords in the at least two conversation rounds to generate a matching result that indicates a degree of similarity between the at least two conversation rounds; and
determine the relevance based on the matching result.

11. The electronic device according to claim 9, wherein the processor is further configured to execute the executable program to, when determining the relevance:
determine tag information representing a conversation topic in each conversation round of the first conversation group;
determine at least one of a matching degree between tag information characterizing topics of the at least two conversation rounds or a contextual relationship between the tag information corresponding to the at least two conversation rounds;
determine the relevance based on the at least one of the matching degree or the contextual relationship.

12. The electronic device according to claim 9, wherein the processor is further configured to execute the executable program to, when determining the relevance:
determine, based on user input information from one conversation round in the first conversation group, scenario label information of the first conversation group;
determine, based on the scenario label information and tag information characterizing topics of the at least two conversation rounds, match results each between one of the at least two conversation rounds and the scenario label information; and
determine the relevance based on the match results.

13. The electronic device according to claim 9, wherein the processor is further configured to execute the executable program to, when determining the time information associated with each conversation round in the first conversation group, for one conversation round in the first conversation group:
obtain first time interval information between the one conversation round and an adjacent conversation round in the first conversation group and second time interval information between the question/answer information of the one conversation round and user input information; and
determine the time information associated with the one conversation round based on at least one of the first time interval information or the second time interval information.

14. The electronic device according to claim 13, wherein the processor configured to execute the executable program to, when determining the number of conversation rounds of the second conversation group:
determine whether the first time interval information exceeds a first threshold and whether the second time interval information exceeds a second threshold; and
in response to the first time interval information exceeding the first threshold and/or the second time interval information exceeding the third threshold, reduce the number of conversation rounds of the second conversation group.

15. The electronic device according to claim 9, wherein the processor is further configured to execute the executable program to, when determining the number of conversation rounds of the second conversation group:
determine a data value representing the relevance;
in response to the data value being larger than a threshold, determine content of the second conversation group based on a conversation topic of a current conversation; and
adjust the number of conversation rounds of the second conversation group based on a difference between the data value and the threshold.

16. The electronic device according to claim 9, wherein the processor is further configured to execute the executable program to, after the conversation with the user ends:
in response to obtaining the user input information again, determine whether the obtained user input information is relevant to the previous conversation; and
in response to determining that the obtained user input information is not relevant to the previous conversation, restart another conversation different from the existing conversation.

17. A non-transitory computer-readable storage medium storing an executable program that, when executed by a processor, causes an electronic device including the processor to:
determine a first conversation group for conducting a conversation with a user, the first conversation group including a plurality of conversation rounds each being a conversation between user input information and corresponding question/answer information;
determine relevance between at least two conversation rounds in the first conversation group and time information associated with each conversation round in the first conversation group during the conversation; and
determine a number of conversation rounds of a second conversation group to be output based on at least one of the relevance or the time information.

18. The storage medium according to claim 17, wherein the executable program, when executed by the processor, further causes the electronic device to, when determining the relevance:
perform matching on keywords in the at least two conversation rounds to generate a matching result that indicates a degree of similarity between the at least two conversation rounds; and
determine the relevance based on the matching result.

19. The storage medium according to claim 17, wherein the executable program, when executed by the processor, further causes the electronic device to, when determining the relevance:
determine tag information representing a conversation topic in each conversation round of the first conversation group;
determine at least one of a matching degree between tag information characterizing topics of the at least two conversation rounds or a contextual relationship between the tag information corresponding to the at least two conversation rounds;
determine the relevance based on the at least one of the matching degree or the contextual relationship.

20. The storage medium according to claim 17, wherein the executable program, when executed by the processor, further causes the electronic device to, when determining the relevance:
determine, based on user input information from one conversation round in the first conversation group, scenario label information of the first conversation group;
determine, based on the scenario label information and tag information characterizing topics of the at least two conversation rounds, match results each between one of the at least two conversation rounds and the scenario label information; and
determine the relevance based on the match results.
